(19) United States
(12) Patent Application Publication
(10) Pub. No.: US 2014/0025410 A1
(43) Pub. Date: Jan. 23, 2014

(54) SYSTEM FOR MANAGEMENT OF ITINERARIES

(71) Applicant: The Boeing Company, Chicago, IL (US)

(72) Inventors: Arthur David Churchman, Puyallup, WA (US); Michael Joseph Duffy, Seattle, WA (US); Garnet William Kevin Hizzey, Snohomish, WA (US); Jeffrey Alan Johnson, Seattle, WA (US); Russell Glen Moul, Kent, WA (US); William Rossington Pickard, JR., Seattle, WA (US)

(21) Appl. No.: 13/943,715

(22) Filed: Jul. 16, 2013

Related U.S. Application Data
(63) Continuation of application No. 13/220,554, filed on Aug. 29, 2011, now abandoned.
Application No. 13/220,554 is a continuation of application No. 10/103,979, filed on Mar. 22, 2002, now abandoned.
(60) Provisional application No. 60/326,319, filed on Oct. 1, 2001.

(51) Int. Cl. G06Q 10/02

(52) U.S. Cl. CPC G06Q 10/025
USPC 705/6

(57) ABSTRACT

A method and system for coordinating travel arrangements. A global travel utility (“GTU”) system allows travel service provider (“TSP”) systems to be connected via a communications link to a “concierge” system. The GTU system includes computer systems that execute the TSP systems and the concierge system. The concierge system provides components for assisting the traveler in creating an itinerary and for storing traveler profile information. The concierge system also includes an event notification component that receives various event notifications from the TSP systems. Upon receiving an unanticipated event notification, the concierge system automatically identifies the itineraries impacted by the event and automatically changes those itineraries as appropriate.

### CROSS-REFERENCE TO RELATED APPLICATION

This application claims the benefit of U.S. Provisional Application No. 60/326,319 entitled “SYSTEM FOR MANAGEMENT OF ITINERARIES” filed on Oct. 1, 2001 and which is hereby incorporated by reference in its entirety.

### TECHNICAL FIELD

The described technology relates generally to a system for management of itineraries and particularly to a system that integrates services provided by travel service providers (“TSPs”) to manage the itinerary of travelers.

### BACKGROUND

A journey, particularly one that includes air travel, can be a frustrating experience for the traveler. Prior to starting the journey, the traveler needs to create an itinerary for the journey. An itinerary typically includes various segments that each defines a service provided by a travel service provider (“TSP”). For example, a simple itinerary may include a segment for traveling via cab from the traveler's home to an airport, a segment for flying to a destination, a segment for traveling via cab at the destination to the hotel, a segment for staying at the hotel, and so on. To create the itinerary, the traveler would typically need to interact with multiple TSPs in order to make the necessary reservations for each segment of the itinerary. The created itinerary may, however, not be exactly as the traveler would like. For example, the traveler may have preferred to fly using an airline through which they have a frequent-flier account, but because all the convenient flights of that airline were booked, the traveler booked a flight with another airline. If the preferred airline has a cancellation on a convenient flight, the traveler typically has no way of knowing that a seat is now available on the preferred airline. The traveler could periodically (e.g., daily) check with the preferred airline for availability on a convenient flight. Such periodic checking is, however, time-consuming and allows another traveler to book that flight before the traveler can check availability.

The really frustrating part of the journey is when travel on a segment does not go as planned. For example, a traveler arriving at an airport may find that their flight has been canceled because of the weather. At that point, the traveler may need to book an alternate flight so that they can continue on their journey. It may be time-consuming to find and book an alternate flight. To book the alternate flight, the traveler may need to contact their travel agent (who may not be available) or they may need to check with various airlines directly. To compound the problem, the other passengers on the canceled flight would be competing at the same time to book an alternate flight. Once the alternate flight has been booked, the traveler may need to contact TSPs from other segments of the itinerary that may be affected by the change. For example, the traveler may need to contact a hotel or a restaurant to let them know of a late arrival or to cancel their reservation, as appropriate.

Therefore, it would be desirable to have a computer system that would assist the traveler in creating their itinerary as well as to monitor the traveler's journey and take appropriate action as unanticipated events (e.g., canceled flight) occur.

### BRIEF DESCRIPTION OF THE DRAWINGS

FIG. 1 is a block diagram illustrating components of the global travel utility (“GTU”) system.

FIG. 2 is a block diagram illustrating components of the publisher/subscriber component.

FIG. 3 is a block diagram illustrating the organization of the publisher/subscriber table in one embodiment.

FIG. 4 is a block diagram illustrating components of the travel database.

FIG. 5 is a display page illustrating the updating of traveler preferences in one embodiment.

FIG. 6 is a display page illustrating the custom rules for a traveler in one embodiment.

FIG. 7 is a display page illustrating creation of a custom rule for a traveler in one embodiment.

FIG. 8 is a block diagram illustrating the layout of an itinerary object in one embodiment.

FIG. 9 is a flow diagram illustrating the processing of the publish component in one embodiment.

FIG. 10 is a flow diagram illustrating the processing of the subscribe itinerary component in one embodiment.

FIG. 11 is a flow diagram illustrating the processing of an event handler for flight availability-related events in one embodiment.

FIG. 12 is a flow diagram illustrating the processing of an event handler for flight data in one embodiment.

FIG. 13 is a flow diagram illustrating the processing of an action to replace a flight segment in one embodiment.

### DETAILED DESCRIPTION

A method and system for coordinating travel arrangements is provided. In one embodiment, a global travel utility (“GTU”) system allows travel service provider (“TSP”) systems to be connected via a communications link to a “concierge” system. The GTU system includes computer systems that execute the TSP systems and the concierge system. The concierge system provides components for assisting the traveler in creating an itinerary and for storing traveler profile information (e.g., preferred airline and preferred way of handling a flight cancellation). The concierge system also includes an event notification component that receives various event notifications (e.g., a canceled flight) from the TSP systems. Upon receiving an unanticipated event notification, the concierge system automatically identifies the itineraries affected by the event and automatically changes those itineraries as appropriate (e.g., books on an alternate flight). The concierge system uses the traveler's profile information, and possibly the traveler's travel history, when determining how to change the itinerary for that traveler. The concierge system may then automatically notify the traveler of the change. In this way, the traveler is relieved of the burden of having to personally respond to the unanticipated events and can travel knowing that the appropriate changes to the itinerary will be made as needed.

In one embodiment, the concierge system uses a publisher/subscriber-based event notification component. Each TSP system registers the events that it will publish with the event notification component. For example, an airline's TSP system may register that it will publish events related to changes in flights. When the concierge system creates an itinerary that includes a flight segment of an airline, it subscribes to the flight-related events of that airline on behalf of the traveler's itinerary. When the airline's TSP system publishes a flight-related event, the traveler's itinerary is notified. The concierge system determines whether a change in the traveler's itinerary may be needed as a result of the event and attempts to make the change. One skilled in the art will appreciate that the concierge system can subscribe to events at varying levels of detail. For example, the concierge system can subscribe to receive event notifications every time a flight for that airline is changed or to receive event notifications only for changes relating to a specific flight. In general, the events may be hierarchically organized, and a subscription can be to any event in the hierarchy.

In one embodiment, the concierge system uses a rules component to respond to event notifications. The rules component may include a rules engine, a facts store, and a rules store. The facts store contains a TSP state portion with information describing the current state of the services of the TSPs that are relevant to the current itineraries. For example, one fact may be that a canceled flight event notification was received at a certain time, and another fact may be that an airport has been closed because of weather. The facts store may also include portions having facts describing the current state of the itineraries, describing the traveler profiles, or describing traveler travel histories. When the concierge system receives an event notification, it updates the facts store to reflect the current state of the services. The rules store includes common rules and may include traveler- or itinerary-specific rules. For example, one common rule may indicate to book an alternate flight when the current flight is delayed more than three hours. One traveler-specific rule may indicate to book an alternative flight when the delay is two hours. The rules may include a condition (e.g., pattern) and action. Whenever the condition is satisfied as indicated by the facts store, the rules engine directs the associated action to be performed. For example, the associated action may be to book an alternate flight giving preference to the preferred airline of the traveler, as indicated by the traveler's profile information.

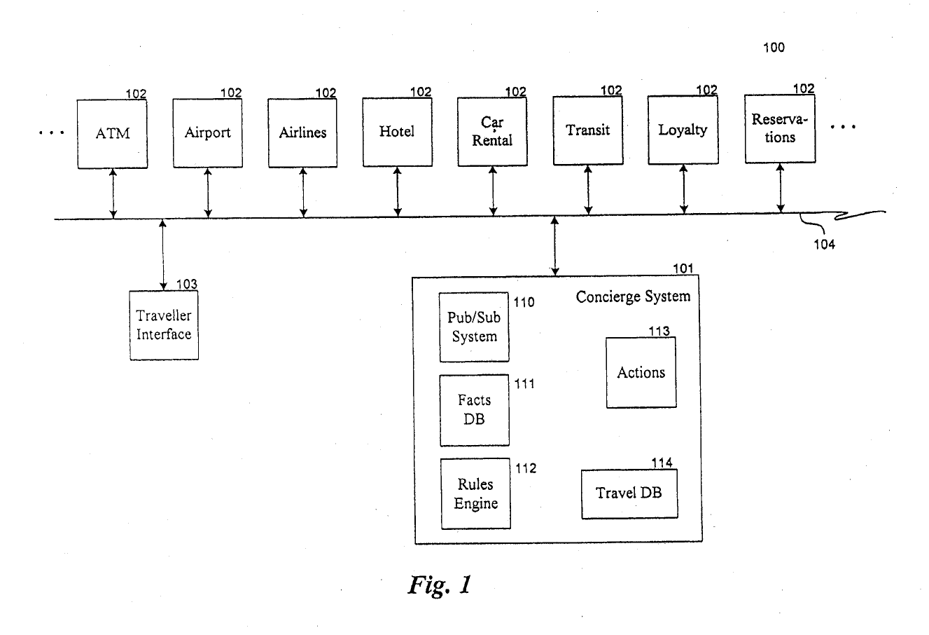

FIG. 1 is a block diagram illustrating components of the GTU system. The GTU system 100 includes a concierge system 101, TSP systems 102, and a traveler interface 103 interconnected via a communications link 104. The TSP systems correspond to computer systems for air traffic management systems, airports, airlines, hotels, car rental agencies, transit authorities, loyalty programs (e.g., frequent-flier programs), reservation systems (e.g., SABRE), weather systems, and so on. Some of these TSPs may be considered secondary TSPs because they do not provide a service that is a necessary part of an itinerary. For example, a weather system TSP would be considered a secondary TSP system, whereas an airline TSP system would be considered a primary TSP system. The TSP systems include components for interacting with the concierge system and for interaction with other systems of the TSP. For example, an airline TSP system may interact with the flight database system of that airline. The concierge system includes a publisher/subscriber component 110, a facts store 111, a rules engine 112, an actions store 113, and a travel store 114. The concierge system may also include a component for assisting a traveler in creating an itinerary. The travel store contains a definition of the current itineraries, traveler profile information, and rules. The publisher/subscriber component receives event notifications from the TSP systems and forwards the event notifications to appropriate itineraries. Each itinerary may have an associated itinerary object and event handlers. The facts store contains information describing the current state of the services of the travel service providers and is updated based on event notifications or actions performed. When the facts store is updated, the rules engine performs the actions associated with the rules as conditions become satisfied. The actions store contains executable code for performing the actions specified by the rules. The computers may include a central processing unit, a memory unit, input devices (e.g., keyboard and pointing devices), output devices (e.g., display devices), and storage devices (e.g., disk drives). The memory and storage devices are computer-readable media that may contain instructions that implement the GTU system. In addition, the data structures and message structures may be stored or transmitted via a data transmission medium, such as a signal on a communications link. The messages (e.g., event notifications) may use the Extensible Markup Language (“XML”) format. Various communications links may be used, such as a dedicated wide area network or the Internet. In one embodiment, the communications link may be similar to the Advanced Network Exchange (“ANX”) provided by Science Applications International Corporation of Vienna, Va. The network preferably supports the transmission of data in a secure manner. The rules engine may use a Rete-based algorithm to determine when conditions are satisfied. (See “Rete: A Fast Algorithm for the Many Pattern/Many Object Pattern Match Problem,” Charles L. Forgy, Artificial Intelligence 19 (1982), pp. 17-37). The Java Expert Shell System (“JESS”) provides one implementation of the Rete algorithm.

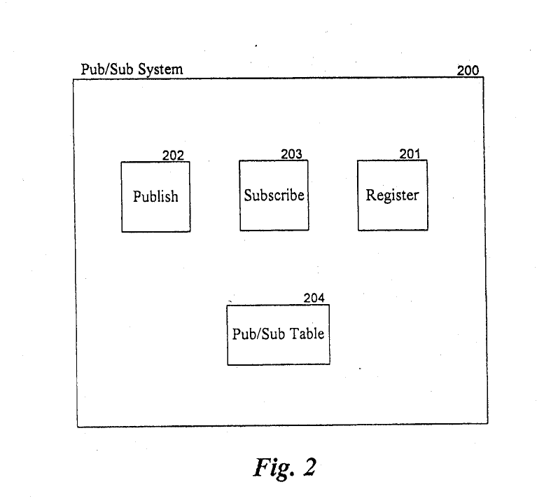

FIG. 2 is a block diagram illustrating components of the publisher/subscriber component. In one embodiment, the publisher/subscriber component 200 includes a register component 201, a publish component 202, a subscriber component 203, and a publisher/subscriber table 204. The register component is invoked on behalf of a TSP system to register a type of event notification that will be provided by that TSP system. The publish component is invoked on behalf of a TSP system when the TSP system publishes an event notification. The subscriber component is invoked when the concierge system subscribes to a certain type of event notification on behalf of an itinerary. The publisher/subscriber table contains an entry for each registered type of event notification for each TSP system. The entry identifies the type of the event notification, the publishing TSP system, and the event handlers of the concierge system that have subscribed to that type of event notification. One skilled in the art will appreciate that the publisher/subscriber table may be implemented in various ways. For example, the publisher/subscriber table may be a data structure that includes multiple tables such as one table with an entry for each allowable event type, another table containing publisher information, and another table containing subscriber information. The register component is passed a type of event notification and the identification of the publishing TSP system, and then adds an entry to the publisher/subscriber table for each type of event notification that is registered. The subscribe component is passed a type of event notification, the identification of a publishing TSP system, and a reference to an event handler. The subscribe component adds the reference to the event handler to the entry of the publisher/subscriber table corresponding to the passed type of event notification and identification of a publishing TSP system. The publish component is passed a type of event notification, the identification of the publishing TSP system, and event data. The publish component invokes each event handler that has subscribed to that type of event notification for the publishing TSP system and passes the event data, which may fully specify the event.

The publisher/subscriber component may also provide data management between the GTU system and law enforcement agencies (e.g., Interpol, FBI, and CIA). The traveler, airport, and national security may be enhanced by correlating these disparate databases to include law enforcement features. For example, the GTU system may access the FBI's 10-most wanted list and flag those persons to reservation or security personnel as appropriate.

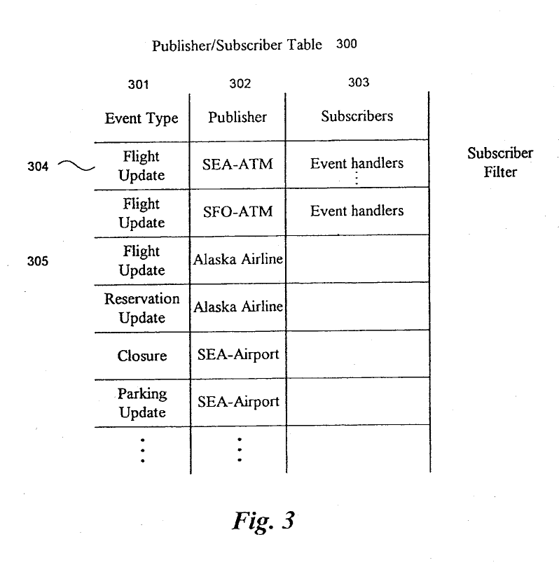

FIG. 3 is a block diagram illustrating the organization of the publisher/subscriber table in one embodiment. The publisher/subscriber table 300 includes an event type column 301, a publisher column 302, and a subscribers column 303. The publisher/subscriber table contains an entry for each unique combination of event type and publisher that has been registered. The subscribers column contains a reference to each event handler that has been specified when the subscriber subscribed to that event type for that publisher. Entry 304 corresponds to an event type of “flight update” for the Seattle air traffic management system, and entry 305 corresponds to an event type of “flight update” for Alaska Airlines.

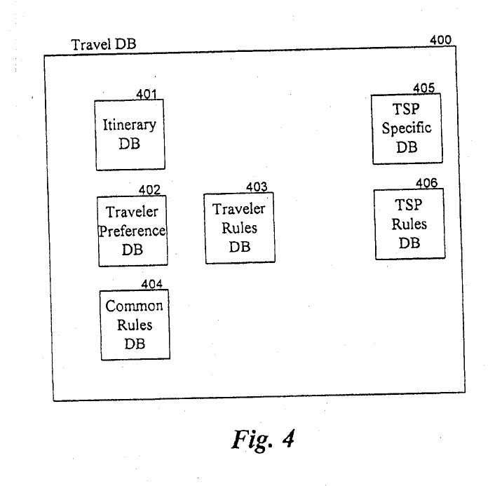

FIG. 4 is a block diagram illustrating components of the travel database. The travel database 400 includes an itinerary store 401, a traveler preference store 402, a traveler rules store 403, a common rules store 404, a TSP store 405, and a TSP rules store 406. The itinerary store contains an entry for each itinerary that has been created by or provided to the concierge system. Each itinerary includes itinerary information and segment information for each segment of the itinerary. The itinerary information may include the identification of the traveler and other information that is common to all segments of the itinerary. The segment information identifies the TSP who is providing the service for that segment and service-specific information that defines the service to be provided. For example, if the service is a flight, then the service-specific information may indicate the airline, the flight number, the assigned seat, and so on. The itineraries may include a parent-child relationship, so that related itineraries can be linked (e.g., when several travelers are traveling together). The traveler preference store may contain an entry for each traveler. The entry identifies various preferences of the traveler, such as preferred airlines, preferred type of airline meal, and so on. The traveler rules store may contain an entry for each traveler. The entry contains the rules that have been specified for that traveler. The common rules store contains rules that are common to all travelers. The TSP store contains information for each TSP. Each TSP is responsible for maintaining its own information and administering access rights to this information. The TSP can restrict access to information that it believes is proprietary or confidential. The TSP rules store contains rules that are specific to a TSP. The travel database may also include a travel history store that includes information describing the past journeys of each traveler.

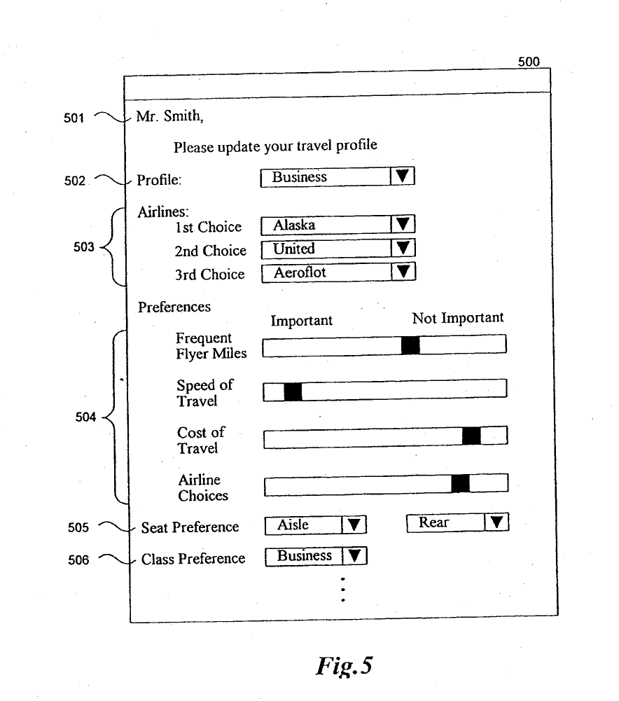

FIGS. 5-7 are display pages illustrating updating of traveler profile information. These display pages may be provided to the traveler via the travel interface and may be mapped to the appropriate traveler interface device such as a personal computer, personal digital assistant, and cell phone. FIG. 5 is a display page illustrating updating of traveler preferences in one embodiment. Display page 500 includes a traveler identification field 501, a profile type field 502, airline choice fields 503, preference scale fields 504, seat preference fields 505, and a class preference field 506. The profile type field is a drop-down list of the type of profiles for the traveler that are currently defined. The types of profiles may include business, personal, hobby, and so on. These types may be predefined or can be specified by the traveler. The airline choice fields are drop-down lists that identify the airlines preferred by the traveler. The preference scale fields are used to indicate whether certain factors are important or not important to the traveler. The traveler can select and move the slider to indicate the level of importance of that factor. The factors may indicate whether to maximize frequent-flier miles, speed of travel, cost of travel, and so on. The seat preference fields are used to specify the types of seats that the traveler prefers. The class preference field is used to specify the class (e.g., first-class) that the traveler prefers. The ellipses at the bottom of the display page indicate that additional preferences may be solicited from the traveler. These preferences may be specific to the type of TSP. For example, the preferences for car rental (e.g., preferred size of car) may be distinct from the preferences for a flight (e.g., preferred type of plane). Some preferences, however, may be common to multiple types of TSPs, such as whether the user prefers nonsmoking sections, which can be used by restaurants, hotels, and car rental agencies. One skilled in the art will appreciate that many different user interfaces can be used to input and display traveler preferences.

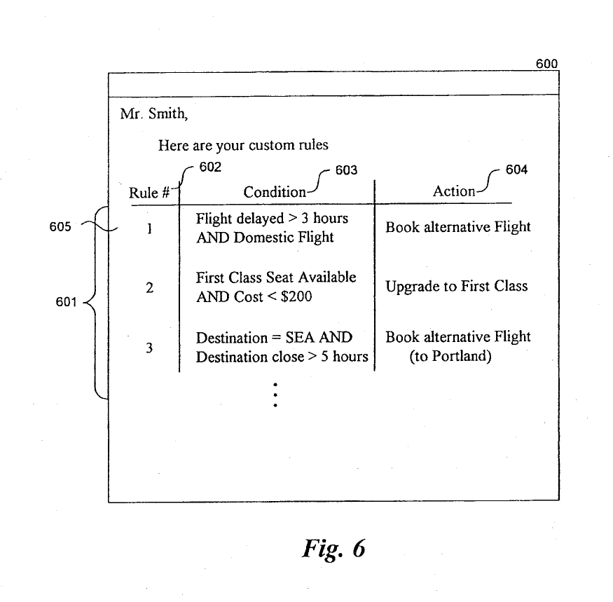

FIG. 6 is a display page illustrating the custom rules for a traveler in one embodiment. Display page 600 includes a rules table 601 that contains an entry for each rule that has been defined for the traveler. The rules table includes a rule number column 602, a condition column 603, and an action column 604. The condition column specifies the conditions for the corresponding rule, and the action column specifies the action to be performed when the condition is satisfied. For example, entry 605 indicates a condition that when a domestic flight is delayed more than three hours, the action is to book an alternate flight. Each action may have corresponding executable code stored in the action store.

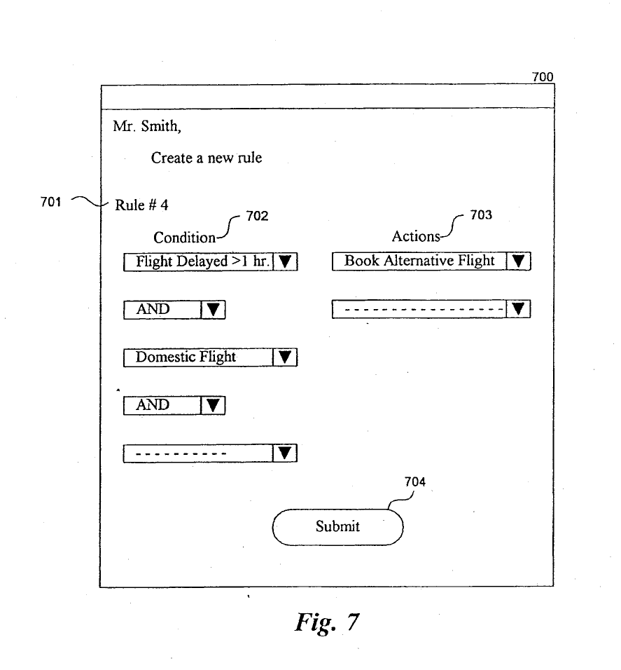

FIG. 7 is a display page illustrating creation of a custom rule for a traveler in one embodiment. Display page 700 includes a rule number field 701, a conditions area 702, an actions area 703, and a submit button 704. The rule number field indicates the rule number for the rule to be created for that traveler. The rules for a traveler may be numbered sequentially. Alternatively, the rules can be identified by traveler-assigned unique names. The conditions area includes three drop-down lists for selection of various conditions. The conditions area also includes two logical operator drop-down lists for selecting logical operators for the conditions. The actions area includes two drop-down lists for selection of the action to be performed when the condition is satisfied. After the selection of the conditions and actions are complete, the traveler selects the submit button to create the new rule. One skilled in the art will appreciate that many different user interfaces may be used to specify the rules. For example, conditions may be dragged and dropped to define the condition for a rule. Also, there may be an arbitrary number of conditions that can be logically combined within a rule. There may be an arbitrary number of actions specified for a rule. In addition, groups of rules may be provided by third parties, purchased by travelers (or companies), and imported into the rules store. For example, a third-party can develop a set of rules that are suitable for managing business travel for corporations. These rules can be purchased by corporations and linked to the traveler records of their employees.

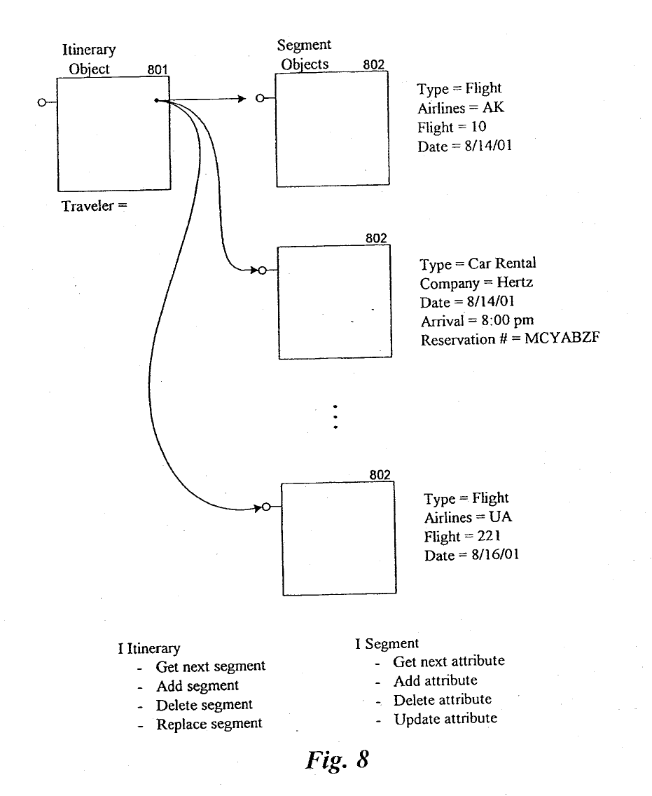

FIG. 8 is a block diagram illustrating the layout of an itinerary object in one embodiment. When an itinerary is created, the concierge system instantiates an itinerary, object 801 for that itinerary. The instantiated itinerary object may be initially stored in main storage (e.g., main memory) and then copied into secondary storage (e.g., disk drive) for storage until the journey begins or until a relevant event is received. The itinerary object may be linked to a segment object 802 for each segment of the itinerary. The itinerary object may provide interface functions such as get next segment, add segment, delete segment, and replace segment as well as functions for setting and retrieving attributes of the itinerary. The segment objects may have functions for setting and retrieving attributes of that segment. The various segment objects may be sub-typed according to the type of segment to which they correspond. For example, the segment types may include a flight segment and a car rental segment. The different segment types may have different sets of attributes associated with them. For example, the flight segment may have a seat attribute, and a car rental segment may have a size attribute. Each itinerary object and each segment object may have associated event handlers for processing related events.

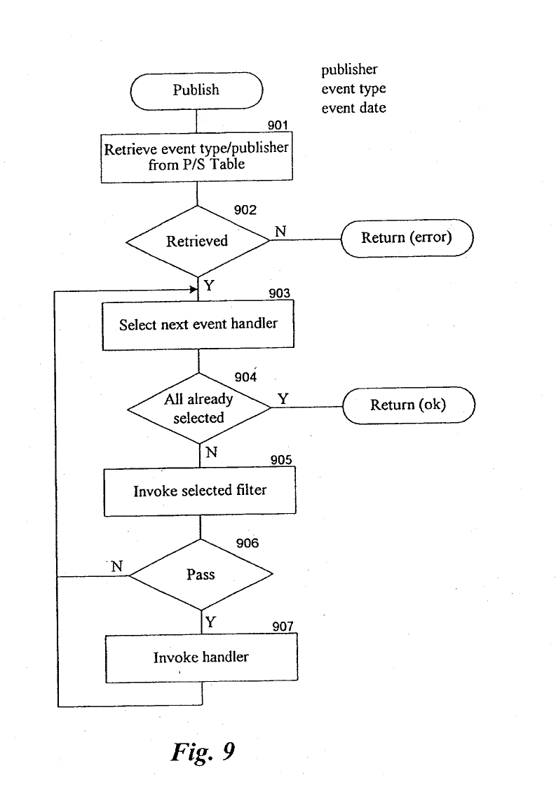

FIGS. 9-13 are flow diagrams illustrating the processing of the components of the concierge system in one embodiment. FIG. 9 is a flow diagram illustrating the processing of the publish component in one embodiment. The publish component is passed an event type, publisher, and event data. The component retrieves the entry corresponding to the event type and publisher from the publisher/subscriber table and passes the event data to each of the event handlers provided by a subscriber. In one embodiment, an event handler may include a filter object and a handler object. The filter object may be used to determine whether the event should be passed to the handler object. In block 901, the component retrieves the entry for the event type and publisher from the publisher/subscriber table. In decision block 902, if the entry was retrieved, then the component continues at block 903, else the component returns an error to the publisher. In blocks 903-907, the component loops selecting each event handler of the retrieved entry for processing. In block 903, the component selects the next event handler for the retrieved entry. In decision block 904, if all the event handlers have already been selected, then the component returns, else the component continues at block 905. In block 905, the component invokes the filter of the selected handler passing the event type, publisher, and event data. In decision block 906, if the filter indicates that the event should be passed to the handler, then the component continues at block 907, else the component loops to block 903 to select the next event handler. In block 907, the component invokes the handler of the selected event handler to process the event. The component then loops to block 903 to select the next event handler.

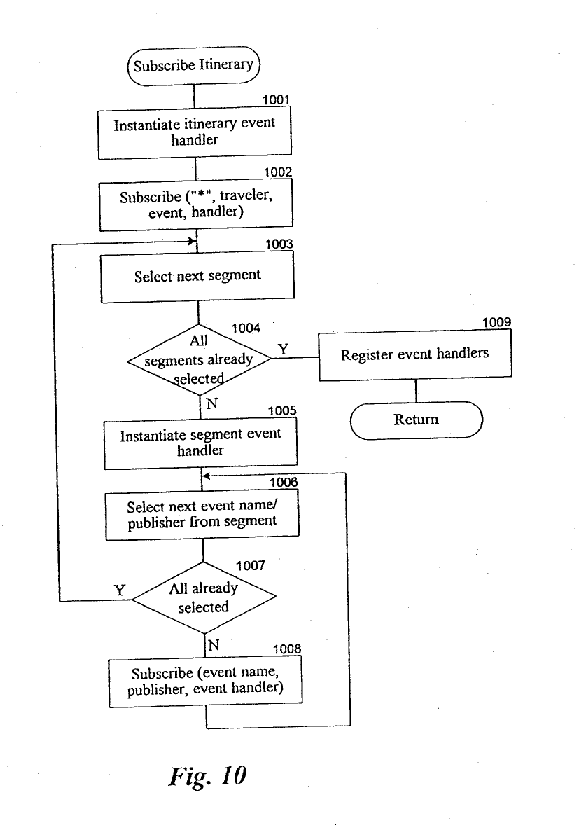

FIG. 10 is a flow diagram illustrating the processing of the subscribe itinerary component in one embodiment. The subscribe itinerary component is passed an itinerary object. The component instantiates an event handler for the itinerary object and for each segment object and subscribes to the appropriate events. The segments may provide attributes describing the events that should be subscribed. In block 1001, the component instantiates an itinerary event handler object. In block 1002, the function subscribes the event handler to receive all events related to the traveler identified in the itinerary object. In blocks 1003-1008, the component loops, creating an event handler for each segment and registering that event handler for each event type of the TSP indicated by the segment object. In block 1003, the component selects the next segment. In decision block 1004, if all segments have already been selected, then the component continues at block 1009, else the component continues at block 1005. In block 1005, the component instantiates an event handler for the selected segment. In blocks 1006-1008, the component loops, selecting each event type of the segment and subscribing to that event type. In block 1006, the component selects the next event type and publisher pair from the segment object. In decision block 1007, if all the event type and publisher pairs have already been selected, then the component loops to block 1003 to select the next segment, else the component continues at block 1008. In block 1008, the component subscribes to the event type and publisher indicating that the event handler is to process the event. Alternatively, each event type and publisher pair can have its own event handler. The component then loops to block 1006 to select the next event type and publisher pair. In block 1009, the function registers the event handlers with the itinerary and segment objects so that a reference to the event handlers can be stored in those objects. The component then returns.

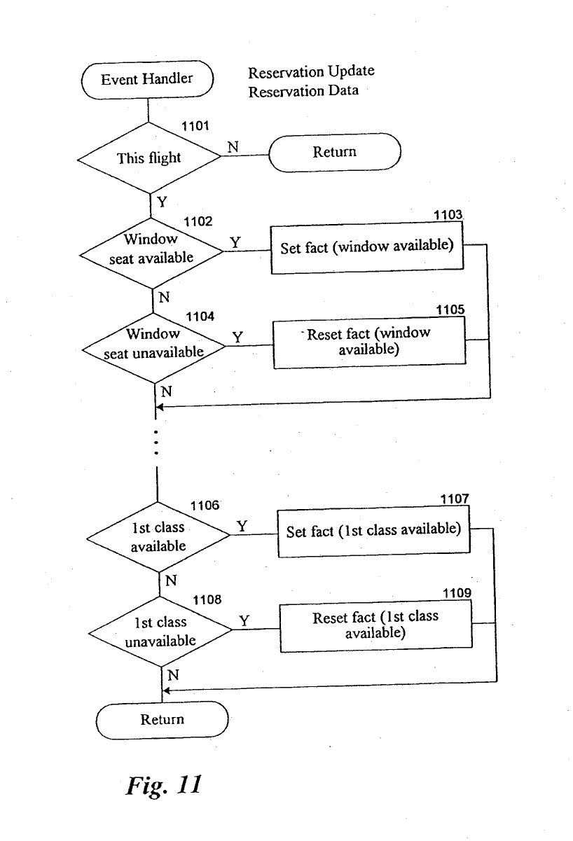

FIG. 11 is a flow diagram illustrating processing of an event handler for flight availability-related events in one embodiment. A flight availability-related event may indicate that certain types of seats have now become available (e.g., because of a cancellation by another traveler). The event handler is passed an indication of the event type, the publisher, and the event data. In decision block 1101, if the event related data indicates that the event is for a flight associated with the event handler as indicated by the attributes of the segment object, then the handler continues at block 1102, else the handler returns because the event is not relevant. In decision block 1102, if the event indicates that a window seat is available, then the handler continues at block 1103, else the handler continues at block 1104. In block 1103, the handler sets a fact in the facts store indicating that the window seat is now available. In decision block 1104, if the event indicates that a window seat is no longer available, then the handler continues at block 1105, else the handler continues at block 1106. In block 1105, the handler resets the fact in the facts store to indicate that a window seat is no longer available. In decision block 1106, if the event indicates that a first-class seat is now available, then the handler continues at block 1107, else the handler continues at block 1108. In block 1107, the handler sets a fact in the facts store indicating that a first-class seat is now available for this flight. In decision block 1108, if the first-class seat is no longer available, then the handler continues at block 1109, else the handler returns. In block 1109, the handler resets the fact in the facts store to indicate that a first-class seat is no longer available. The handler then returns. The ellipses indicate that many more types of events can be processed by the handler. In this example, events to reset the facts may be generated by the TSP systems. Alternatively, the action that attempts to upgrade a segment to first-class may fail because another traveler has in the interim booked that first-class seat. In such a case, that action may reset the fact in the facts store to indicate that the first-class seat is no longer available. One skilled in the art will appreciate that each type of event could have its own event handler. In such a case, the event handler would not need to serially test for each possible type of event.

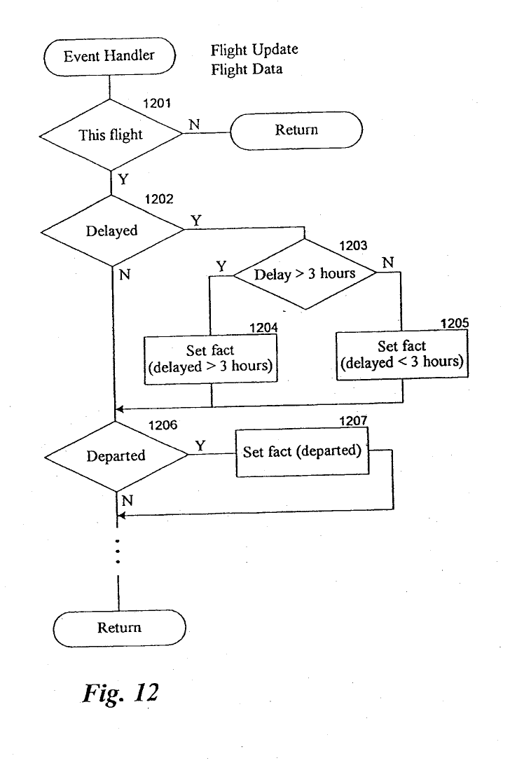

FIG. 12 is a flow diagram illustrating the processing of an event handler for flight data in one embodiment. The handler is passed an indication of the event, the publisher, and the event data. In decision block 1201, if the event data indicates that the event is for this flight, then the handler continues at block 1202, else the handler returns. In block 1202, if the event indicates that the flight is delayed, then the handler continues at block 1203, else the handler continues at block 1206. In decision block 1203, if the delay is greater than three hours, then the handler continues at block 1204, else the handler continues at block 1205. In block 1204, the handler sets a fact in the facts store to indicate that the flight is delayed more than three hours. In block 1205, the handler sets the fact in the facts store to indicate that the flight is delayed less than three hours. In decision block 1206, if the event indicates that the flight has departed from the airport, then the handler continues at block 1207, else the handler continues processing the other events as indicated by the ellipsis. In block 1207, the handler sets a fact in the facts store to indicate that the flight has departed.

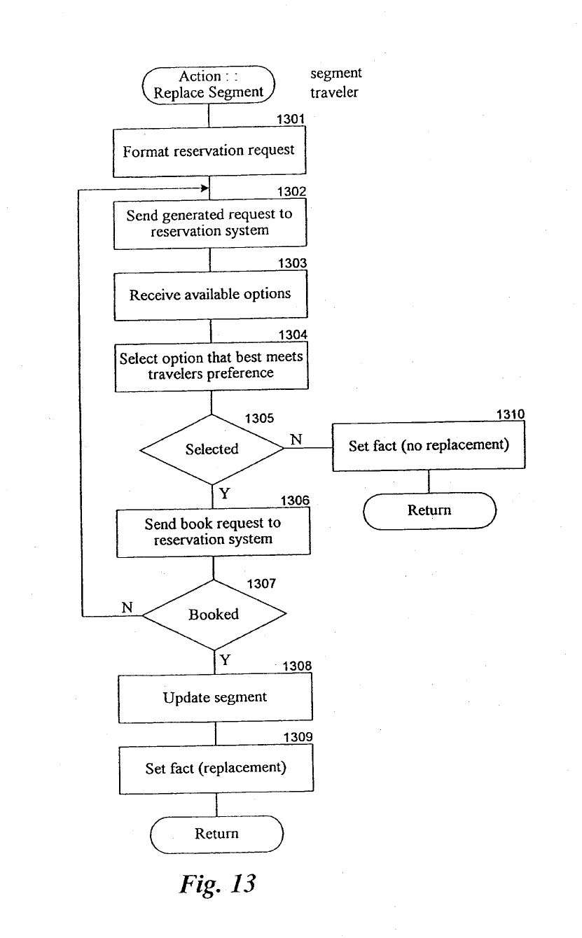

FIG. 13 is a flow diagram illustrating the processing of an action to replace a flight segment in one embodiment. The action is passed an indication of the segment and the traveler. In block 1301, the action formats a reservation request. The reservation request may include the parameters for the flight to be selected. In blocks 1302-1308, the action loops attempting to book an alternate flight. In block 1302, the action sends the generated request to the system of the reservation TSP (e.g., SABRE). In block 1303, the action receives the available options. In block 1304, the action selects the option that best meets the traveler's profile. In decision block 1305, if an option is selected that meets the traveler's preference, then the action continues at block 1306, else the action continues at 1310. In block 1306, the action sends a book request to the reservation system to book the selected flight. In decision block 1307, if the flight was successfully booked, then the action continues at block 1308, else the action loops to block 1302 to repeat the process of retrieving available options. In block 1308, the action updates the segment objects to reflect the booked flight. In block 1309, the function sets a fact in the facts store to indicate that the segment has been replaced. The action then returns. In block 1310, the action sets a fact in the facts store to indicate that no replacement was made and returns.

GTU Scenario

The following scenario describes a typical journey managed by the concierge system. The traveler created an itinerary that includes segments for flying on Continental Airlines from Dallas to Seattle for business and then on Alaska Airlines from Seattle to Anchorage for pleasure, segments for staying at hotels in Seattle and Anchorage, segments for transit in Seattle (via taxi), a segment for renting a car in Anchorage, and a segment for receiving a fishing license in Alaska. The reservation may have been created using the concierge system based on the traveler's personal profile and travel history. The concierge system may store complete travel history for each traveler and use the history when creating or modifying an itinerary. The concierge system helps to ensure the traveler's privacy by providing only as much information to each TSP as is needed to make the appropriate reservation. The itinerary may have been planned through the web site of one of the TSPs, such as Alaska Airlines. The TSP may have collected information indicating that the traveler wanted to see their client in Seattle and then wished to travel to Anchorage for a week of salmon fishing on the Copper River. The TSP system then interacted with the concierge system to create an itinerary based on the traveler's profile and travel history. The traveler then received notification of the itinerary and had an opportunity to approve, modify, or disapprove of the itinerary.

When the concierge system received an indication that the itinerary had been approved, it generated itinerary and segment objects for the itinerary and corresponding event handlers. The objects and handlers may be stored in secondary storage and moved into main storage when relevant events are received. The subscribed events may include air traffic management events, Dallas, Seattle, and Anchorage airport events, Alaska and Continental airline events, Anchorage restaurant events, Seattle hotel events, Seattle ground transit events, Anchorage rental car events, and Anchorage Fish and Wildlife Department events. The traveler may also have indicated special preferences and rules that should be applied only to this itinerary.

On the morning of the traveler's departure, the traveler received a call that confirmed the flight number and its status, the departure date and time, seat assignments, meal selections, weather and traffic conditions for the drive to the airport, along with a suggestion for an optimal parking location and driving route. During the day of travel, the traveler received a call from the concierge system suggesting an alternate route along with a suggested departure time because the recommended route became congested. The concierge system may also have notified the airport and the airlines when the traveler was en route to the airport.

When the traveler arrived at the airport, the traveler checked their bags that have radio frequency tags using a baggage handling system within the parking garage. The traveler directed two bags to go directly to Anchorage and another bag to go to Seattle first. The traveler then answered security questions at the security kiosk. The traveler's cell phone provided identification information to the kiosk, and the kiosk verified the traveler's identification using an authentication system (e.g., a retina scanner or other biometric identification). The concierge system may receive events related to the baggage and forward the information to the airlines and hotels. The traveler used their cell phone to confirm the departure gate and to find the fastest route to the gate. The concierge system received an event from the airport system indicating that certain security stations are congested. The concierge system recommended a route to avoid the congestion.

When the plane is ready to be boarded, the concierge system received an event notification from Continental Airlines. The concierge system alerted the traveler that they should proceed to the gate before the agent announced the boarding. At the gate, the traveler's cell phone announced the traveler to the airline's system and the traveler was authenticated. The name of the traveler was announced to the gate attendant using an earpiece and a picture of the traveler was displayed. The attendant greeted the traveler by name. The traveler's cell phone may communicate via a technology such as BlueTooth. The air traffic management system of Dallas notified the concierge system that the flight was en route.

While en route to Seattle, the traveler received a call indicating that the client meeting had been postponed to the next day. As a result, the traveler needed to spend another night in Seattle. The traveler notified the concierge system of the change to the itinerary using their personal digital assistant. The concierge system determined that there was no availability in the reserved hotel for the second night. As a result, it canceled the existing hotel reservation and reserved a room in another hotel for both nights. The concierge system also changed the flight reservation for the Seattle to Anchorage segment, and changed the dates of the hotel reservation and rental car reservations in Anchorage. While still en route, the traveler was notified of the updated itinerary. Since the traveler would have an extra night in Seattle, the concierge system suggested that the traveler may want to attend a performance of a ballet that night. The concierge system reviewed the traveler's travel history, concluded that a ballet would be of interest, and found that good seats were still available at the ballet.

When the traveler arrived in Seattle, the concierge system notified a taxi when the traveler's baggage was at the baggage carousel. A picture of the traveler was displayed to the taxi driver for easy identification of the traveler, and the traveler's name was displayed on a reader board on top of the taxi. The concierge system notified the hotel when the taxi was approaching, and the traveler was automatically checked in. The concierge system received a room number and access code from the hotel's TSP system. The concierge system then notified the traveler via the traveler's personal digital assistant of the room number and access code. As the traveler approached the room, the traveler's personal digital assistant unlocked the room door using the access code. The traveler continued on the journey with continued monitoring and guidance from the concierge system.

From the foregoing, it will be appreciated that although specific embodiments of the invention have been described for purposes of illustration, various modifications may be made without deviating from the spirit and scope of the invention. For example, the concierge system may be implemented using principles of Battlefield Management Computer Systems that are used to monitor and control events and resources engaged in a battle. The items involved in a journey may include the travelers, materials related to the travelers (e.g., baggage), and TSP assets or services (e.g., flights, airplanes, cars, hotel rooms). The journey may be considered similar to a soldier's battle plan, and the TSP events may be considered similar to battlefield events. The concepts of the invention can also be applied to domains other than travel. For example, in the medical domain, the concierge system can be adapted to receive events from medical service providers, rather than travel service providers. The rules of such a medical concierge system can indicate what actions should be taken with certain events such as automatically scheduling an appointment with a cardiologist when a patient is referred to one by a primary care provider or when a patient is diagnosed with a possible heart condition. The concierge system can be adapted in a similar way to process education records to assist in lifelong learning, traffic information to assist commuters, and product information to assist shoppers. More generally, the concierge system is a management system that adjusts plans (e.g., plans of a user) based on profiles when events are received. Accordingly, the invention is not limited except as by the appended claims.

1. A computer system for coordinating travel arrangements, the computer system comprising:
a communications link;
a plurality of travel service provider (“TSP”) systems connected to the communications link for publishing events relating to the TSP; and
a concierge system connected to the communications link to receive itineraries of travelers, profiles of travelers, and events via the communications link, the concierge system including a rules component having rules with conditions and associated actions and a rules engine,
wherein the rules engine is configured to decide, in response to a received unanticipated event, how to adjust each affected itinerary based on the traveler's profile information, the traveler's interests, the traveler's travel history during creation of a traveler's itinerary, and the traveler's travel history during the traveler's journey, and
wherein the rules engine is configured to adjust each affected itinerary without intervention by the traveler for the itinerary and in accordance with the received unanticipated events.

2. The computer system of claim 1 wherein the concierge system includes a publisher/subscriber component for receiving publications of events from the TSP systems.

3. (canceled)

4. (canceled)

5. The computer system of claim 1 wherein the rules include rules common to multiple travelers and rules specific to a traveler.

6. The computer system of claim 1 wherein the rules component further includes a facts store having facts set in response to receiving events from TSP systems.

7. (canceled)

8. The computer system of claim 6 wherein at least one of the actions is for setting facts to reflect the current state of a fact after an attempt to adjust the itineraries.

9. The computer system of claim 1 wherein at least one of the actions is for contacting a TSP system to assist in modifying an itinerary.

10. The computer system of claim 1 wherein the rules engine implements a Rete algorithm.

11. The computer system of claim 1 wherein the concierge system includes a profile component for managing traveler profiles.

12. The computer system of claim 11 wherein the profile component includes a user interface for specifying user preferences and user rules.

13. The computer system of claim 1 including a traveler interface connected to the communications link for communicating with travelers.

14. The computer system of claim 12 wherein the traveler interface communicates with a traveler using a telephone, personal digital assistant, or personal computer.

15. The computer system of claim 1 wherein the TSP systems include air traffic management systems, airport systems, airline systems, and reservations systems.

16. The computer system of claim 5 wherein the TSP systems include hotel systems and/or car rental systems.

17. The computer system of claim 1 including a component for generating itineraries.

18. The computer system of claim 1 wherein the communications link is secure.

19. A method, in a computer system having a memory and a processor, for assisting a traveler with a journey, the method comprising:
receiving and storing an itinerary for the journey, the itinerary having one or more segments;
creating rules having conditions and associated actions specifying the response to unanticipated events at least partially based on a traveler's profile information and a traveler's travel history;
receiving notifications from travel service providers (“TSPs”) or the traveler of at least one unanticipated event relating to the one or more segments of the itinerary; and
upon receiving a notification of the at least one unanticipated event, identifying the rules whose conditions are satisfied by the occurrence of the unanticipated event and modifying the itinerary based on the occurrence of the unanticipated event based, at least in part, on the traveler's profile information, the traveler's interests, the traveler's travel history during creation of a traveler's itinerary, and the traveler's travel history during the traveler's journey,
wherein at least the receiving and identifying are performed by the processor executing instructions stored in the memory.

20. (canceled)

21. The method of claim 19 wherein one of the rules is customized to the traveler.

22. The method of claim 19 where each segment corresponds to services provided by a different TSP, and the method further includes modifying multiple segments of the itinerary.

23. The method of claim 19 including providing profiles of travelers, and wherein deciding how to modify is based on the profile of the traveler.

24. The method of claim 23 wherein the profile of the traveler includes TSP-specific information provided by the TSP.

25. The method of claim 24 wherein only the TSP that provided the TSP-specific information can access the TSP-specific information.

26. The method of claim 19 wherein one of the segments corresponds to an airline flight.

27. The method of claim 26 wherein the at least one received event indicates that the airline flight is delayed and the modifying includes booking an alternate flight.

28. The method of claim 27 including notifying the traveler of the booked alternate flight.

29. The method of claim 27 including modifying other segments of the itinerary based on arrival time of the booked alternate flight.

30. The method of claim 19 wherein a segment corresponds to a hotel reservation.

31. The method of claim 30 wherein when the at least one received event indicates that the traveler is near the hotel, automatically sending hotel room access information to the traveler.

32. The method of claim 31 wherein the hotel room access information includes identification of the hotel room and an access code for the hotel room.

33. The method of claim 30 wherein when the at least one received event indicates that the traveler is near the hotel, automatically registering the traveler at the hotel.

34. The method of claim 19, further comprising notifying TSPs affected by the modifying of the segment.

35. The method of claim 19 wherein the at least one received event indicates that a different characteristic of service of a segment is now available and the modifying includes changing the segment to the different characteristic of service.

36. The method of claim 35 wherein the characteristic of service of an air flight is first class or coach class.

37. The method of claim 35 wherein the characteristic of service of an air flight is location of a seat.

38. The method of claim 19 wherein an itinerary encompasses air transportation, ground transportation, and hotel accommodations.

39. (canceled)

40. A concierge system for coordinating travel arrangements over a communications link connected to at least one travel service provider (“TSP”) and traveler, the system comprising:
a publisher/subscriber component to connect to the communications link to receive an itinerary of the traveler, a profile of the traveler, and unanticipated events affecting the traveler's itinerary;
a rules store including conditions and associated actions to adjust at least one of the itineraries; and
a rules engine to, in response to at least one received unanticipated event and when at least one of the conditions is satisfied, decide how to adjust the itinerary in accordance with the at least one of the received unanticipated events based on the traveler's profile information, the traveler's interests, the traveler's travel history during creation of a traveler's itinerary, and the traveler's travel history during the traveler's journey.

41. The concierge system of claim 40 wherein at least one of the received events is provided by the at least one TSP.

42. The concierge system of claim 40 wherein the communications link is further connected to a law enforcement agency.

43. The concierge system of claim 42 wherein the received event is law enforcement information regarding the traveler.

44. The concierge system of claim 40 wherein the received event is medical information.

45. The concierge system of claim 40 wherein at least one of the received events is from the traveler.

46. The concierge system of claim 40, further comprising a facts store having traveler travel histories, and wherein the rule engine is to adjust the itinerary according to the travel history of the traveler.

47. The concierge system of claim 40 wherein multiple itineraries for travelers are received and at least some of the itineraries includes a relationship to link several of the itineraries.

48. The concierge system of claim 40 wherein the itinerary includes segments with functions and the system further includes event handlers for processing related received events.

49. The method of claim 19, further comprising updating the stored itinerary to reflect the modification.
